(19) United States
(12) Patent Application Publication
(10) Pub. No.: US 2018/0217234 A1
(43) Pub. Date: Aug. 2, 2018

(54) Diffractive Optical Element for a Time-of-Flight Sensor and Method of Operation of Same

(71) Applicant: 4Sense, Inc., Delray Beach, FL (US)

(72) Inventor: Stanislaw K. Skowronek, New York, NY (US)

(73) Assignee: 4Sense, Inc., Delray Beach, FL (US)

(21) Appl. No.: 15/418,013

(22) Filed: Jan. 27, 2017

(51) Int. Cl. G01S 7/481; G01S 17/66; G01S 17/08; G01S 7/48

(52) U.S. Cl. CPC G01S 7/4814; G01S 7/4808; G01S 17/08; G01S 17/66

(57) ABSTRACT

A system and method of dynamically controlling a light source is described herein. Modulated light that includes an input signal riding on illumination light can be emitted in a monitoring area, and an object can be detected in the monitoring area and passively tracked. Based on passively tracking the object, tracking data associated with the object can be received. Based on the tracking data, the illumination light can be steered towards the object in the monitoring area to increase the amount of illumination light striking the object and steered away from one or more sections of the monitoring area that are unoccupied by the object. Reflections of the modulated light can be received from the object and based on the received reflections, a depth distance of the object can be provided.

### FIELD

The subject matter described herein relates to time-of-flight (ToF) sensors and more particularly, to systems for dynamically controlling the illumination of the ToF sensors.

### BACKGROUND

Several companies develop and manufacture ToF sensors, which are designed to illuminate an area with modulated light, typically in the near-infrared range of the light spectrum, and to capture reflections of the emitted light from objects in the area. The ToF sensor may detect phase shifts of a signal modulating the light and may translate these differences into distances between the ToF sensor and the objects. A typical operating range for a ToF sensor is less than twenty feet.

To increase the range of a ToF sensor, a more sophisticated lens arrangement may be integrated into the ToF sensor. Unfortunately, this solution increases the cost and complexity of the system. As another solution, the ToF sensor can be modified to increase the intensity of the light that it emits. The added intensity indeed enables the ToF sensor to expand the area that it illuminates. Several drawbacks, however, arise from this configuration. In particular, the size of the illuminator must be enlarged, which results in additional expense and power consumption, to prevent the illumination from being too concentrated. Light that is above a certain intensity level may cause damage to a human that is within the operating range of the ToF sensor. Moreover, excess illumination that hits targets that are relatively close to the ToF sensor may produce reflections that either overwhelm the ToF sensor or otherwise lead to inaccurate readings.

Another problem that originates from excess illumination is multipath propagation (MPP). Specifically, as an object moves farther away from the ToF sensor, the reflections of light off the object may be corrupted with reflections from another object, such as a ceiling or wall. In some cases, the reflections from the object and the other object may add up or even cancel each other out, such as if the input signals modulating the reflections were 180 degrees out of phase. In either case, the quality of the distance measurements of the ToF sensor will suffer.

### SUMMARY

A ToF sensor for dynamically controlling modulated light is described herein. The ToF sensor can include a light source that can be configured to emit modulated light in a monitoring area in which the modulated light is comprised of an input signal riding on illumination light. The ToF sensor may also include a diffractive optical element (DOE) optically coupled to the light source in which the DOE can be configured to receive the modulated light and to modulate the illumination light of the modulated light. The ToF sensor can also include a processor that is communicatively coupled to the DOE. The processor can be configured to receive tracking data from one or more sensors of a passive tracking system in which the tracking data may be associated with an original object in the monitoring area being passively tracked by the passive tracking system. The processor may also be configured to, based on the tracking data, signal the DOE to adjust the modulation of the illumination light to steer the illumination light towards the original object in the monitoring area to increase the amount of illumination light striking the original object and to steer the illumination light away from one or more sections of the monitoring area unoccupied by the original object.

In one arrangement, the DOE may be a spatial light modulator that can be configured to modulate the phase or amplitude of the illumination light. In addition, the DOE can be configured to modulate the illumination light without affecting the input signal.

In another arrangement, the tracking data may include new positional data associated with the original object that may correspond to movement of the original object to a new location in the monitoring area. The processor can be further configured to, based on the new positional data, signal the DOE to adjust the modulation of the illumination light to steer the illumination light towards the original object at the new location and to steer the illumination light away from one or more updated sections of the monitoring area unoccupied by the original object. The tracking data may be associated with both the original object and a new object in the monitoring area being passively tracked by the passive tracking system. The processor may be further configured to, based on the tracking data, signal the DOE to adjust the modulation of the illumination light to steer the illumination light towards both the original object and the new object in the monitoring area and to steer the illumination light away from one or more sections of the monitoring area unoccupied by both the original object and the new object.

The ToF sensor can also include a detector, which can be configured to receive reflections of the modulated light from the original object. The processor can be further configured to determine a depth distance of the original object based on the received reflections of modulated light. In another arrangement, the processor can be communicatively coupled to the light source, and the processor can be further configured to signal the light source to adjust the wavelength of the illumination light.

In one embodiment, the ToF sensor can be a sensor that may be part of the passive tracking system, and the one or more sensors of the passive tracking system may include the ToF sensor, a visible-light sensor, a thermal sensor, or a sonar device. As an example, the original object is a human. In this example, the processor can be further configured to receive tracking data from the sensors that indicate the lack of presence of the human and in response to the lack of presence of the human, deactivate the light source.

A method of dynamically controlling a light source is described herein. The method can include the steps of emitting in a monitoring area modulated light that includes an input signal riding on illumination light and detecting an original object in the monitoring area and passively tracking the object. Based on passively tracking the original object, tracking data associated with the original object can be received. Based on the tracking data, the illumination light can be steered towards the original object in the monitoring area to increase the amount of illumination light striking the original object and away from one or more sections of the monitoring area that are unoccupied by the original object. The method can also include the steps of receiving reflections of the modulated light from the original object and based on the received reflections, providing a depth distance of the original object in the monitoring area.

Passively tracking the object may be done with one or more sensors of a passive tracking system. As an example, the sensors can include a visible-light sensor, a thermal sensor, a ToF sensor, or a sonar device. Receiving the tracking data associated with the original object may include receiving the tracking data from one or more of the visible-light sensor, the thermal sensor, the ToF sensor, or the sonar device.

In one arrangement, steering the illumination light towards the original object in the monitoring area and away from one or more sections of the monitoring area that are unoccupied by the original object may be facilitated by selectively modulating the phase or amplitude of the illumination light. In another arrangement, steering the illumination light towards the original object in the monitoring area and away from one or more sections of the monitoring area that are unoccupied by the original object may be facilitated by selectively adjusting the wavelength of the illumination light.

The method can further include the steps of receiving updated tracking data associated with the original object indicating the original object has moved to a new location in the monitoring area. The method can also include the step of, based on the updated tracking data, steering the illumination light towards the new location of the original object in the monitoring area and away from one or more updated sections of the monitoring area that are unoccupied by the original object. In this case, the method can further include the steps of receiving reflections of the modulated light from the original object in the new location of the monitoring area and based on the received reflections of the modulated light from the original object in the new location, providing an updated depth distance of the original object in the monitoring area.

The method may also include the step of receiving updated tracking data associated with the original object and a new object in the monitoring area at the same time as the original object. Based on the updated tracking data, the illumination light may be steered towards both the original object and the new object in the monitoring area and away from one or more sections of the monitoring area that are unoccupied by both the original object and the new object.

A method of increasing an operating range of a ToF sensor in a monitoring area while simultaneously reducing the effects of multipath propagation (MPP) arising from the operation of the ToF sensor is described herein. The method can include the steps of emitting from the ToF sensor modulated light that includes an input signal riding on non-visible illumination light and receiving tracking data associated with an object in the monitoring area. Based on the tracking data, the phase of the illumination light may be modulated to steer the illumination light towards the object in the monitoring area to increase the amount of illumination light directed at the object and away from one or more sections of the monitoring area that are unoccupied by the original object to minimize the amount of illumination light reaching the sections. The method may also include the steps of receiving reflections of the modulated light from the object and based on the received reflections, providing a depth distance of the object in the monitoring area.

Receiving tracking data associated with the object may include receiving tracking data associated with the object from one or more sensors of a passive tracking system configured to passively track the object in the monitoring area. The method can also include the step of receiving updated tracking data associated with the object that indicate the object is in a new location of the monitoring area. Based on the updated tracking data, the phase of the illumination light can be modulated to steer the illumination light towards the new location of the object and away from one or more updated sections of the monitoring area that are unoccupied by the object. The updated sections may include sections previously and newly unoccupied by the object.

In one arrangement, the method may include the step of determining that the object is within a predetermined distance of the ToF sensor. Based on the determination, the steered illumination light can be correspondingly diffused to reduce the increased amount of illumination light directed at the object.

### BRIEF DESCRIPTION OF THE DRAWINGS

FIG. 1 illustrates an example of a passive-tracking system for passively tracking one or more objects.

FIG. 2 illustrates a block diagram of an example of a passive-tracking system for passively tracking one or more objects.

FIG. 3A illustrates an example of a passive-tracking system with a field-of-view.

FIG. 3B illustrates an example of a coordinate system with respect to a passive-tracking system.

FIG. 3C illustrates an example of an adjusted coordinate system with respect to a passive-tracking system.

FIG. 4 illustrates a block diagram of an example of a ToF sensor.

FIG. 5A illustrates an example of light steering by a ToF sensor.

FIG. 5B illustrates another example of light steering by a ToF sensor.

For purposes of simplicity and clarity of illustration, elements shown in the above figures have not necessarily been drawn to scale. For example, the dimensions of some of the elements may be exaggerated relative to other elements for clarity. Further, where considered appropriate, reference numbers may be repeated among the figures to indicate corresponding, analogous, or similar features. In addition, numerous specific details are set forth to provide a thorough understanding of the embodiments described herein. Those of ordinary skill in the art, however, will understand that the embodiments described herein may be practiced without these specific details.

### DETAILED DESCRIPTION

As previously explained, current ToF sensors have limited operating ranges. Efforts to increase such ranges by raising the intensity of the light source or by implementing new lens designs have not produced effective solutions.

To address this problem, a system and method of dynamically controlling a light source is described herein. Modulated light that includes an input signal riding on illumination light can be emitted in a monitoring area, and an object can be detected in the monitoring area and passively tracked. Based on passively tracking the object, tracking data associated with the object can be received. Based on the tracking data, the illumination light can be steered towards the object in the monitoring area to increase the amount of illumination light striking the object and can be steered away from one or more sections of the monitoring area that are unoccupied by the object. Reflections of the modulated light can be received from the object, and based on the received reflections, a depth distance of the object can be provided.

In view of this arrangement, a ToF sensor can smartly direct light to increase its operating range. Moreover, by directing light away from unimportant sections of a monitoring area, erroneous readings originating from MPP can be reduced. This improvement can be accomplished without incurring excessive expenses or harming living objects that may be passively tracked.

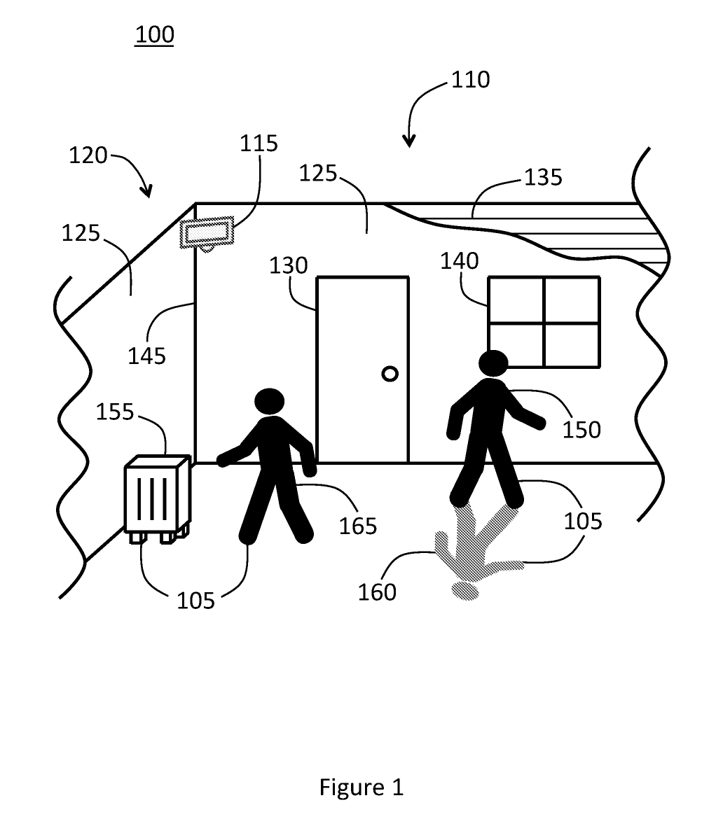

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. Those of skill in the art, however, will understand that the embodiments described herein can be practiced without these specific details.

Several definitions that are applicable here will now be presented. The term “sensor” is defined as a component or a group of components that include at least some circuitry and are sensitive to one or more stimuli that are capable of being generated by or reflected off or originating from a living being, composition, machine, etc. or are otherwise sensitive to variations in one or more phenomena associated with such living being, composition, machine, etc. and provide some signal or output that is proportional or related to the stimuli or the variations. An “object” is defined as any real-world, physical object or one or more phenomena that results from or exists because of the physical object, which may or may not have mass. An example of an object with no mass is a human shadow. The term “monitoring area” is an area or portion of an area, whether indoors, outdoors, or both, that is the actual or intended target of observation or monitoring for one or more sensors. A “light source” is defined as a component that emits light, where the emission results from electrical power or a chemical reaction (or both). A “diffractive optical element” is defined as a physical structure that receives light from a light source and manipulates the light to enable the light to be directed towards or away from one or more areas. A “spatial light modulator” is defined as a diffractive optical element that imposes some form of spatially varying modulation on light received from a light source. The term “modulate” and variations thereof are defined as varying one or more properties of one or more electromagnetic waves to affect the waves in some predetermined manner.

A “frame” is defined as a set or collection of data that is produced or provided by one or more sensors or other components. As an example, a frame may be part of a series of successive frames that are separate and discrete transmissions of such data in accordance with a predetermined frame rate. A “reference frame” is defined as a frame that serves as a basis for comparison to another frame. A “visible-light frame” is defined as a frame that at least includes data that is associated with the interaction of visible light with an object or the presence of visible light in a monitoring area or other location. A “sound frame” or a “sound-positioning frame” is defined as a frame that at least includes data that is associated with the interaction of sound with an object or the presence of sound in a monitoring area or other location. A “temperature frame” or a “thermal frame” is defined as a frame that at least includes data that is associated with thermal radiation emitted from an object or the presence of thermal radiation in a monitoring area or other location. A “positioning frame” or a “modulated-light frame” is defined as a frame that at least includes data that is associated with the interaction of modulated light with an object or the presence of modulated light in a monitoring area or other location. The term “tracking data” is defined as data that at least includes positioning data associated with an object. As an example, tracking data may be part of the set or collection of data that makes up a frame.

A “thermal sensor” is defined as a sensor that is sensitive to at least thermal radiation or variations in thermal radiation emitted from an object. A “time-of-flight sensor” is defined as a sensor that emits modulated light and is sensitive to at least reflections of the modulated light from an object. A “visible-light sensor” is defined as a sensor that is sensitive to at least visible light that is reflected off or emitted from an object. A “transducer” is defined as a device that is configured to at least receive one type of energy and convert it into a signal in another form. A “sonar device” is defined as a set of one or more transducers, whether such set of transducers is configured for phased-array operation or not. A “processor” is defined as a circuit-based component or group of circuit-based components that are configured to execute instructions or are programmed with instructions for execution (or both), and examples include single and multi-core processors and co-processors. A “pressure sensor” is defined as a sensor that is sensitive to at least variations in pressure in some medium. Examples of a medium include air or any other gas (or gases) or liquid. The pressure sensor may be configured to detect changes in other phenomena.

The term “circuit-based memory element” is defined as a memory structure that includes at least some circuitry (possibly along with supporting software or file systems for operation) and is configured to store data, whether temporarily or persistently. A “communication circuit” is defined as a circuit that is configured to support or facilitate the transmission of data from one component to another through one or more media, the receipt of data by one component from another through one or more media, or both. As an example, a communication circuit may support or facilitate wired or wireless communications or a combination of both, in accordance with any number and type of communications protocols.

The term “communicatively coupled” is defined as a state in which signals may be exchanged between or among different circuit-based components, either on a uni-directional or bi-directional basis, and includes direct or indirect connections, including wired or wireless connections. The term “optically coupled” is defined as a state, condition, or configuration in which light may be exchanged between or among different circuit-based components, either on a uni-directional or bi-directional basis, and includes direct or indirect connections, including wired or wireless connections. A “hub” is defined as a circuit-based component in a network that is configured to exchange data with one or more passive-tracking systems or other nodes or components that are part of the network and is responsible for performing some centralized processing or analytical functions with respect to the data received from the passive-tracking systems or other nodes or components.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). Additional definitions may appear below.

Referring to FIG. 1, an example of a system 100 for tracking one or more objects 105 in a monitoring area 110 is shown. In one arrangement, the system 100 may include one or more passive-tracking systems 115, which may be configured to passively track any number of the objects 105. The term “passive-tracking system” is defined as a system that is capable of passively tracking an object. The term “passively track” or “passively tracking” is defined as a process in which a position of an object, over some time, is monitored, observed, recorded, traced, extrapolated, followed, plotted, or otherwise provided (whether the object moves or is stationary) without at least the object being required to carry, support, or use a device capable of exchanging signals with another device that are used to assist in determining the object's position. In some cases, an object that is passively tracked may not be required to take any active step or non-natural action to enable the position of the object to be determined. Examples of such active steps or non-natural actions include the object performing gestures, providing biometric samples, or voicing or broadcasting certain predetermined audible commands or responses. In this manner, an object may be tracked without the object acting outside its ordinary course of action for a particular environment or setting. For purposes of this description, passive tracking may include tracking an object such that one, two, or three positional coordinates of the object are determined and updated over time (if necessary). For example, passive tracking may include a process in which only two positional coordinates of an object are determined and updated.

In one case, the object 105 may be a living being. Examples of living beings include humans and animals (such as pets, service animals, animals that are part of an exhibition, etc.). Although plants are not capable of movement on their own, a plant may be a living being that is tracked or monitored by the system described herein, particularly if they have some significant value and may be vulnerable to theft or vandalism. An object 105 may also be a non-living entity, such as a machine or a physical structure, like a wall or ceiling. As another example, the object 105 may be a phenomenon that is generated by or otherwise exists because of a living being or a non-living entity, such as a shadow, disturbance in a medium (e.g., a wave, ripple or wake in a liquid), vapor, or emitted energy (like heat or light).

The monitoring area 110 may be an enclosed or partially enclosed space, an open setting, or any combination thereof. Examples include man-made structures, like a room, hallway, vehicle or other form of mechanized transportation, porch, open court, roof, pool or other artificial structure for holding water of some other liquid, holding cells, or greenhouses. Examples also include natural settings, like a field, natural bodies of water, nature or animal preserves, forests, hills or mountains, or caves. Examples also include combinations of both man-made structures and natural elements.

In the example here, the monitoring area 110 is an enclosed room 120 (shown in cut-away form) that has a number of walls 125, an entrance 130, a ceiling 135 (also shown in cut-away form), and one or more windows 140, which may permit natural light to enter the room 120. Although coined as an entryway, the entrance 130 may be an exit or some other means of ingress and/or egress for the room 120. In one embodiment, the entrance 130 may provide access (directly or indirectly) to another monitoring area 110, such as an adjoining room or one connected by a hallway. In such a case, the entrance 130 may also be referred to as a portal, particularly for a logical mapping scheme. In another embodiment, the passive-tracking system 115 may be positioned in a corner 145 of the room 120 or in any other suitable location. These parts of the room 120 may also be considered objects 105.

As will be explained below, the passive-tracking system 115 may be configured to passively track any number of objects 105 in the room 120, including both stationary and moving objects 105. In this example, one of the objects 105 in the room 120 is a human 150, another is a portable heater 155, and yet another is a shadow 160 of the human 150. The shadow 160 may be caused by natural light entering the room through the window 140. A second human 165 may also be present in the room 120. Examples of how the passive-tracking system 115 can distinguish the human 150 from the portable heater 155, the shadow 160, and the second human 165 and passively track the human 150 (and the second human 165) can be found in U.S. patent application Ser. No. 15/359,525, filed on Nov. 22, 2016, which is herein incorporated by reference.

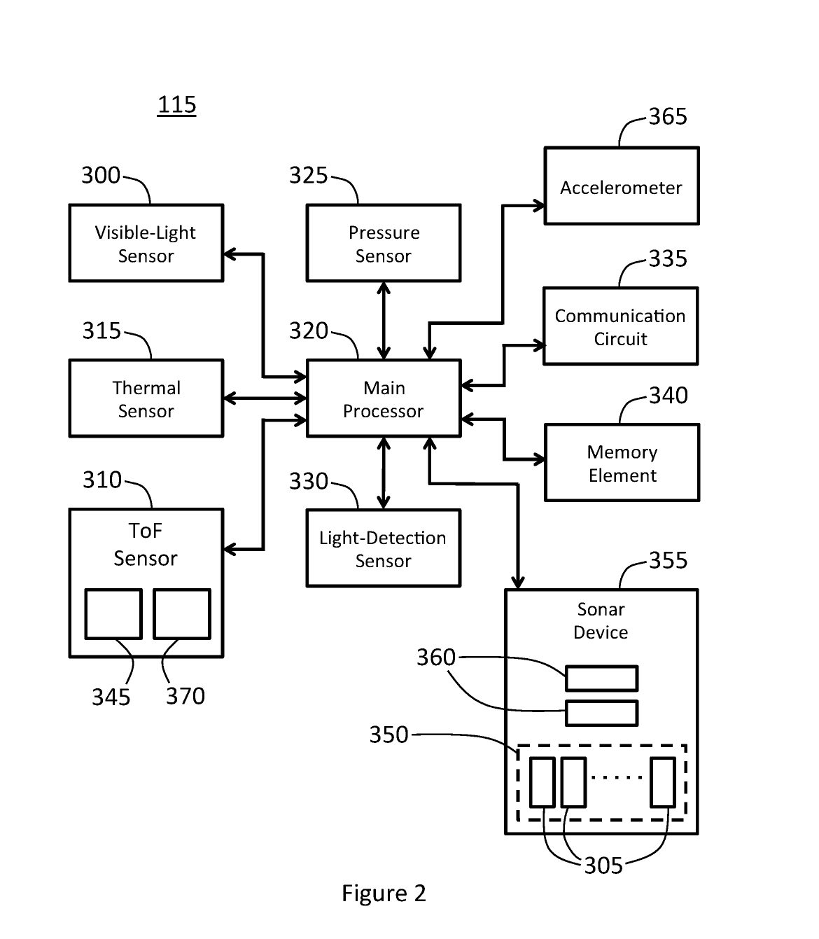

Referring to FIG. 2, a block diagram of an example of a passive-tracking system 115 is shown. In this embodiment, the passive-tracking system 115 can include one or more visible-light sensors 300, one or more sound transducers 305, one or more time-of-flight (ToF) sensors 310, one or more thermal sensors 315, and one or more main processors 320. The passive-tracking system 115 may also include one or more pressure sensors 325, one or more light-detection sensors 330, one or more communication circuits 335, and one or more circuit-based memory elements 340. Each of the foregoing devices can be communicatively coupled to the main processor 320 and to each other, where necessary. Although not pictured here, the passive-tracking system 115 may also include other components to facilitate its operation, like power supplies (portable or fixed), heat sinks, displays or other visual indicators (like LEDs), speakers, and supporting circuitry.

In one arrangement, the visible-light sensor 300 can be a visible-light camera that is capable of generating images or frames based on visible light that is reflected off any number of objects 105. These visible-light frames may also be based on visible light emitted from the objects 105 or a combination of visible light emitted from and reflected off the objects 105. In this description, the non-visible light may also contribute to the data of the visible-light frames, if such a configuration is desired. The rate at which the visible-light sensor 300 generates the visible-light frames may be periodic at regular or irregular intervals (or a combination of both) and may be based on one or more time periods. In addition, the rate may also be set based on a predetermined event (including a condition), such as adjusting the rate in view of certain lighting conditions or variations in equipment. The visible-light sensor 300 may also be capable of generating visible-light frames based on any suitable resolution and in full color or monochrome. In one embodiment, the visible-light sensor 300 may be equipped with an IR filter (not shown), making it responsive to only visible light. As an alternative, the visible-light sensor 300 may not be equipped with the IR filter, which can enable the sensor 300 to be sensitive to IR light.

The sound transducer 305 may be configured to at least receive soundwaves and convert them into electrical signals for processing. As an example, the passive-tracking system 115 can include an array 350 of sound transducers 305, which can make up part of a sonar device 355. The sonar device 355 may be referred to as a sensor of the passive-tracking system 115, even though it may be comprised of various discrete components, including at least some of these described here. As another example, the sonar device 355 can include one or more sound transmitters 360 configured to transmit, for example, ultrasonic sound waves in at least the monitored area 110. That is, the array 350 of sound transducers 305 may be integrated with the sound transmitters 360 as part of the sonar device 355. The sound transducers 305 can capture and process the sound waves that are reflected off the objects 105.

In one embodiment, the sound transducers 305 and the sound transmitters 360 may be physically separate components. In another arrangement, one or more of the sound transducers 305 may be configured to both transmit and receive soundwaves. In this example, the sound transmitters 360 may be part of the sound transducers 305. If the sound transducers 305 and the sound transmitters 360 are separate devices, the sound transducers 305 may be arranged horizontally in the array 350, and the sound transmitters 360 may be positioned vertically in the array 350. This configuration may be reversed, as well. In either case, the horizontal and vertical placements can enable the sonar device 355 to scan in two dimensions. The sound transducers 305 may also be configured to capture speech or other sounds that are audible to humans or other animals, which may originate from sources other than the sound transmitters 360.

The ToF sensor 310 can be configured to emit modulated light in the monitoring area 110 or some other location and to receive reflections of the modulated light off an object 105, which may be within the monitoring area 110 or other location. The ToF sensor 310 can convert the received reflections into electrical signals for processing. As part of this step, the ToF sensor 310 can generate one or more frames of positioning frames or modulated-light frames in which the data of such frames is associated with the reflections of modulated light off the objects 105. This data may also be associated with light from sources other than those that emit modulated-light and/or from sources other than those that are part of the ToF sensor 310. If the ToF sensor 310 is configured with a filter to block out wavelengths of light that are outside the frequency (or frequencies) of its emitted modulated light, the light from these other sources may be within such frequencies. As an example, the ToF sensor 310 can include one or more modulated-light sources 345 and one or more imaging sensors 370, and the phase shift between the illumination and the received reflections can be translated into positional data. As an example, the light emitted from the ToF sensor 310 may have a wavelength that is outside the range for visible light, such as infrared (including near-infrared) light. Additional information about the ToF sensor 310 will be presented below.

The thermal sensor 315 can detect thermal radiation emitted from any number of objects 105 in the monitoring area 110 or some other location and can generate one or more thermal or temperatures frames that include data associated with the thermal radiation from the objects 105. The objects 105 from which the thermal radiation is emitted can be from living beings or from machines, like portable heaters, engines, motors, lights, or other devices that give off heat and/or light. As another example, sunlight (or other light) that enters the monitoring area 110 (or other location) may also be an object 105, as the thermal sensor 315 can detect thermal radiation from this condition or from its interaction with a physical object 105 (like a floor). As an example, the thermal sensor 315 may detect thermal radiation in the medium-wavelength-infrared (MWIR) and/or long-wavelength-infrared (LWIR) bands.

The main processor 320 can oversee the operation of the passive-tracking system 115 and can coordinate processes between all or any number of the components (including the different sensors) of the system 115. Any suitable architecture or design may be used for the main processor 320. For example, the main processor 320 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software or cause it to be executed (or any combination of the foregoing). Further examples of suitable processors include, but are not limited to, a central processing unit (CPU), an array processor, a vector processor, a field-programmable gate array (FPGA), a programmable logic array (PLA), an application specific integrated circuit (ASIC), and programmable logic circuitry. The main processor 320 can include at least one hardware circuit (e.g., an integrated circuit) configured to carry out instructions contained in program code.

In arrangements in which there is a plurality of main processors 320, such processors 320 can work independently from each other or one or more processors 320 can work in combination with each other. In one or more arrangements, the main processor 320 can be a main processor of some other device, of which the passive-tracking system 115 may or may not be a part. This description about processors may apply to any other processor that may be part of any system or component described herein, including any of the individual sensors or other components of the passive-tracking system 115. That is, any one of the sensors of the passive-tracking system 115 can have one or more processors similar to the main processor 320 described here.

The pressure sensor 325 can detect pressure variations or disturbances in virtually any type of medium, such as air or liquid. As an example, the pressure sensor 325 can be an air pressure sensor that can detect changes in air pressure in the monitored area 110 (or some other location), which may be indicative of an object 105 entering or otherwise being in the monitored area 110 (or other location). For example, if a human passes through an opening (or portal) to a monitored area 110, a pressure disturbance in the air of the monitored area 110 is detected by the pressure sensor 325, which can then lead to some other component taking a particular action.

The pressure sensor 325 may be part of the passive-tracking system 115, or it may be integrated with another device, which may or may not be positioned within the monitoring area 110. For example, the pressure sensor 325 may be a switch that generates a signal when a door or window that provides ingress/egress to the monitoring area 110 is opened, either partially or completely. Moreover, the pressure sensor 325 may be configured to detect other disturbances, like changes in an electro-magnetic field or the interruption of a beam of light (i.e., visible or non-visible). As an option, no matter what event may trigger a response in the pressure sensor 325, a minimum threshold may be set (and adjusted) to provide a balance between ignoring minor variations that would most likely not be reflective of an object 105 that warrants passive tracking entering the monitoring area 110 (or other location) and processing disturbances that most likely would be. In addition to acting as a trigger for other sensors or components of the passive-tracking system 115, the pressure sensor 325 may also generate one or more pressure frames, which can include data based on, for example, pressure variations caused by or originating from an object 105.

The light-detection circuit 330 can detect an amount of light in the monitoring area 110 (or other location), and this light may be from any number and type of sources, such as natural light, permanent or portable lighting fixtures, portable computing devices, flashlights, fires (including from controlled or uncontrolled burning), or headlights. Based on the amount of light detected by the light-detection circuit 330, one or more of the other devices of the passive-tracking system 115 may be activated or deactivated, examples of which will be provided later. Like the pressure sensor 325, the light-detection circuit 330 can be a part of the passive-tracking system 115 or some other device. In addition, minimum and maximum thresholds may be set (and adjusted) for the light-detection circuit 330 for determining which lighting conditions may result in one or more different actions occurring.

The communication circuits 335 can permit the passive-tracking system 115 to exchange data with other passive-tracking systems 115, a hub, or any other device, system, or network. To support various type of communication, including those governed by certain protocols or standards, the passive-tracking system 115 can include any number and kind of communication circuits 335. For example, communication circuits 335 that support wired or wireless (or both) communications may be used here, including for both local- and wide-area communications. Examples of protocols or standards under which the communications circuits 335 may operate include Bluetooth, Near Field Communication, and Wi-Fi, although virtually any other specification for governing communications between or among devices and networks may govern the communications of the passive-tracking system 115. Although the communication circuits 335 may support bi-directional exchanges between the system 115 and other devices, one or more (or even all) of such circuits 335 may be designed to only support unidirectional communications, such as only receiving or only transmitting signals.

The circuit-based memory elements 340 can be include any number of units and type of memory for storing data. As an example, a circuit-based memory element 340 may store instructions and other programs to enable any of the components, devices, sensors, and systems of the passive-tracking system 115 to perform their functions. As an example, a circuit-based memory element 340 can include volatile and/or non-volatile memory. Examples of suitable data stores here include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. A circuit-based memory element 340 can be part of the main processor 320 or can be communicatively connected to the main processor 320 (and any other suitable devices) for use thereby. In addition, any of the various sensors and other parts of the passive-tracking system 115 may include one or more circuit-based memory elements 340.

The passive-tracking system 115 is not necessarily limited to the foregoing design, as it may not necessarily include each of the previously listed components. Moreover, the passive-tracking system 115 may include components beyond those described above. For example, instead of or in addition to the sonar device 355, the system 115 can include a radar array, such as a frequency-modulated, continuous-wave (FMCW) system, that emits a sequence of continuous (non-pulsed) signals at different frequencies, which can be linearly spaced through the relevant spectrum. The results, which include the amplitude and phase of the reflected waves, may be passed through a Fourier transform to recover, for example, spatial information of an object 105. One example of such spatial information is a distance of the object 105 from the array. In some FMCW systems, the distances wrap or otherwise repeat—a discrete input to a Fourier transform produces a periodic output signal—and a tradeoff may be necessary between the maximum range and the number of frequencies used.

Some or all of the various components (e.g., sensors) of the passive-tracking system 115 may be oriented in a particular direction. These orientations may be fixed, although they may also be adjusted if necessary. As part of the operation of the passive-tracking system 115, some of the outputs of the different components of the system 115 may be compared or mapped against those of one or more other components of the system 115. To accommodate such an arrangement, the orientations of one or more components of the passive-tracking system 115 may be set so that they overlap one another.

A particular sensor of the passive-tracking system 115 may have a field-of-view (FoV), which may define the boundaries of an area that are within a range of operation for that sensor. As an example, the visible-light sensor 300, depending on its structure and orientation, may be able to capture image data of every part of a monitoring area 110 or only portions of the area 110. The FoV for one or more of the other components of the passive-tracking system 115 may be substantially aligned with the FoV of the visible-light sensor 300. For example, the FoV for the array 350 of sound transducers 305, ToF sensor 310, thermal sensor 315, and pressure sensor 325 may be effectively matched to that of the visible-light sensor 300. As part of this arrangement, the FoV for one particular component of the passive-tracking system 115 may be more expansive or narrower in comparison to that of another component of the passive-tracking system 115, although at least some part of their FoVs may be aligned. This alignment process can enable data from one or more of the sensors of the passive-tracking system 115 to be compared and merged or otherwise correlated with data from one or more other sensors of the system 115. Some benefits to this arrangement include the possibility of using a common coordinate or positional system among different sensors and confirmation of certain readings or other data from a particular sensor.

If desired, the orientation of the passive-tracking system 115 (as a whole) may be adjusted, either locally or remotely, and may be moved continuously or periodically according to one or more intervals. In addition, the orientations of one or more of the sensors (or other components) of the passive-tracking system 115 may be adjusted or moved in a similar fashion, either individually (or independently) or synchronously with other sensors or components. Any changes in orientation may be done while maintaining the alignments of one or more of the FoVs, or the alignments may be dropped or altered. Optionally, the system 115 or any component thereof may include one or more accelerometers 365, which can determine the positioning or orientation of the system 115 overall or any particular sensor or component that is part of the system 115. The accelerometer 365 may provide, for example, attitude information with respect to the system 115.

As presented as an earlier example, a passive-tracking system 115 may be assigned to a monitoring area 110 (or some other location), which may be a room 120 that has walls 125, an entrance 130, a ceiling 135, and windows 140 (see FIG. 1). Any number of objects 105 may be in the room 120 at any particular time, such as the human 150, the portable heater 155, and the shadow 160. As also noted above, many of the sensors of the passive-tracking system 115 may generate one or more frames, which may include data associated with, for example, the monitoring area 110, in this case, the room 120. For example, the visible-light sensor 300 may generate at any particular rate one or more visible-light frames that include visible-light data associated with the room 120. As part of this process, visible light that is reflected off one or more objects 105 of the room 120, like the walls 125, entrance 130, ceiling 135, windows 140, and heater 155, can be captured by the visible-light sensor 300 and processed into the data of the visible-light frames. In addition, as pointed out earlier, the visible light that is captured by the visible-light sensor 300 may be emitted from an object 105, and this light may affect the content of the visible-light frames.

In one arrangement, one or more of these visible-light frames may be set as visible-light reference frames, to which other visible-light frames may be compared. For example, in an initial phase of operation, the visible-light sensor 300 may capture images of the room 120 and can generate the visible-light frames, which may contain data about the layout of the room 120 and certain objects 105 in the room 120 that are present during this initial phase. Some of the objects 105 may be permanent fixtures of the room 120, such as the walls 125, entrance 130, ceiling 135, windows 140, and heater 155 (if the heater 155 is left in the room 120 for an extended period of time). As such, these initial visible-light frames can be set as visible-light reference frames and can be stored in, for example, the circuit-based memory element 340 or some other database for later retrieval. Because these objects 105 may be considered permanent or recognized fixtures of the room 120, as an option, a decision can be made that passively tracking such objects 105 is unnecessary or not helpful. Other objects 105, not just permanent or recognized fixtures of the room 120, may also be ignored for purposes of passively tracking.

As such, because these insignificant objects 105 may not be passively tracked, they can be used to narrow the focus of the passive-tracking process. For example, assume one or more visible-light reference frames include data associated with one or more objects 105 that are not to be passively tracked. When the visible-light sensor 300 generates a current visible-light frame and forwards it to the main processor 320, the main processor 320 may retrieve the visible-light reference frame and compare it to the current visible-light frame. As part of this comparison, the main processor 320 can ignore the objects 105 in the current frame that are substantially the same size and are in substantially the same position as the objects 105 of the reference frame. The main processor 320 can then focus on new or unidentified objects 105 in the current visible-light frame that do not appear as part of the visible-light reference frame, and they may be suitable candidates for passive tracking. The principles and examples described above may also apply to some of the other components, such as the sonar device 355, the thermal sensor 315, or the ToF sensor 310, of the passive-tracking system 115.

As part of passively tracking objects 105, the main processor 320 can receive and analyze frames from one or more of the sensors of the passive-tracking system 115. Some of this analysis may include the main processor 320 comparing the data of the frames to one or more corresponding reference frames. In one embodiment, following the comparison, some of the data of the frames from the different sensors may be merged for additional analysis or actions. For example, relevant data from the frames generated by the visible-light sensor 300 and the thermal sensor 315 may be combined. Based on this combination, the main processor 320 may determine positional or tracking data associated with an object 105 in the monitoring area 110, and this tracking data may be updated over time. In one embodiment, this tracking data may conform to a known reference system, such as a predetermined coordinate system, with respect to the location of the passive-tracking system 115.

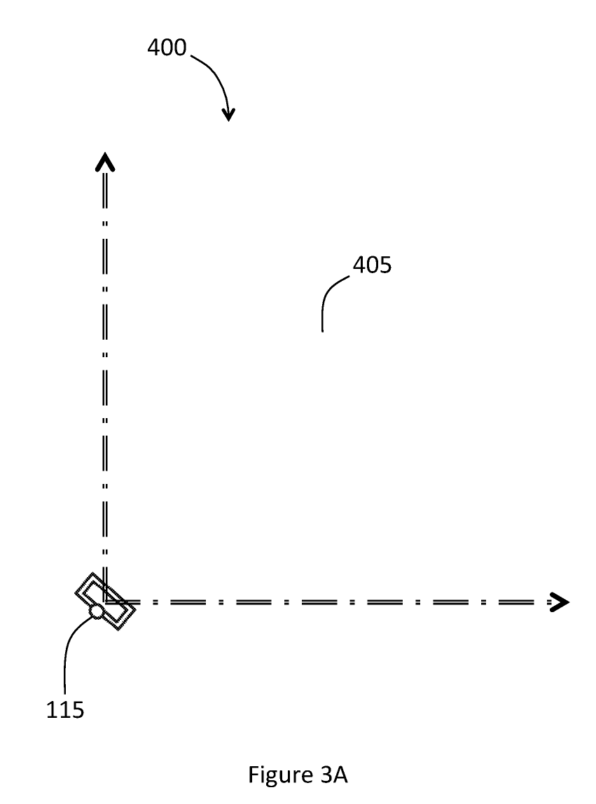

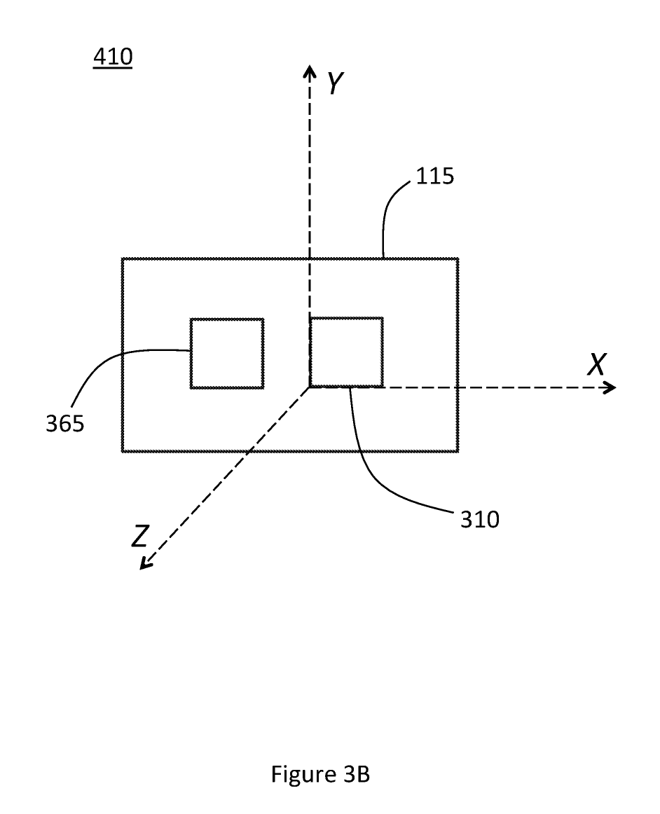

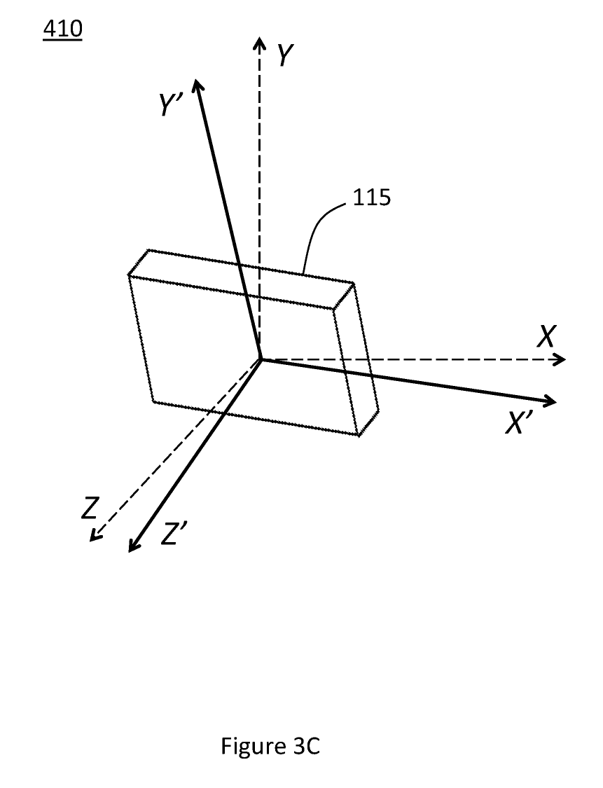

Referring to FIG. 3A, an example of the passive-tracking system 115 in a monitoring area 110 with a field of view (FoV) 400 is shown. In one arrangement, the FoV 400 is the range of operation of a sensor of the passive-tracking system 115. For example, the visible-light sensor 300 may have a FoV 400 in which objects 105 or portions of the objects 105 within the area 405 of the FoV 400 may be detected and processed by the visible-light sensor 300. In addition, the ToF sensor 310 and the thermal sensor 315 may each have a FoV 400. In one arrangement, the FoVs 400 for these different sensors may be effectively merged, meaning that the coverage areas for these FoVs 400 may be roughly the same. As such, the merged FoVs 400 may be considered an aggregate or common FoV 400. Of course, such a feature may not be necessary, but by relying on a common FoV 400, the data from any of the various sensors of the passive-tracking system 115 may be easily correlated with or otherwise mapped against that of any of the other sensors.

As an example, the coverage area of each (individual) FoV 400 may have a shape that is comparable to a pyramid or a cone, with the apex at the relevant sensor. To ensure substantial overlapping of the individual FoVs 400 for purposes of realizing the common FoV 400, the sensors of the passive-tracking system 115 may be positioned close to one another and may be set with similar orientations. As another example, the range of the horizontal component of each (individual) FoV 400 may be approximately 90 degrees, and the common FoV 400 may have a similar horizontal range as a result of the overlapping of the individual FoVs 400. This configuration may provide for full coverage of at least a portion of a monitoring area 110 if the passive-tracking system 115 is positioned in a corner of the area 110. The FoV 400 (common or individual), however, may incorporate other suitable settings or even may be adjusted, depending on, for instance, the configurations of the monitoring area 110.

In one embodiment, the FoV 400 may represent a standard or default range of operation of one or more sensors of the system 115, although the FoV 400 may not necessarily represent or otherwise match the coverage area of emissions of some of the sensors. For example, as will be explained below, the operation of one or more sensors may be adjusted, depending on one or more factors. As a specific example, the FoV 400 may represent the coverage area of the light that the ToF sensor 310 emits in a conventional manner. In this example, the light is emitted in a diffuse (and arbitrary) fashion. In some cases, the emitted light may be manipulated to cause it to steer in a certain direction, and this operation may shrink the area that is illuminated by the light. As such, even though the ToF sensor 310 may have an FoV 400 with a conical shape, the FoV 400 may not necessarily set all the illumination patterns that may be realized from the ToF sensor 310.

Referring to FIG. 3B, a positional or coordinate system 410 may be defined for the passive-tracking system 115. In one arrangement, the X axis and the Y axis may be defined by the ToF sensor 310, and the Z axis may be based on a direction pointing out the front of the ToF sensor 310 in which the direction is orthogonal to the X and Y axes. In this example, the ToF sensor 310 may be considered a reference sensor. Other sensors of the system 115 or various combinations of such sensors (like the visible-light sensor 300 and the ToF sensor 310) may act as the reference sensor(s) for purposes of defining the X, Y, and Z axes. To achieve consistency in the positional data that originates from the coordinate system 410, the sensors of the system 115 may be pointed or oriented in a direction that is at least substantially similar to that of the reference sensor. In one arrangement, each of the sensors that provide positional data related to one or more objects may initially generate such data in accordance with a spherical coordinate system (not shown), which may include values for azimuth, elevation, and depth distance. Note that not all sensors may be able to provide all three spherical values. The sensors (or possibly the main processor 320 or some other device) may then convert the spherical values to Cartesian coordinates based on the X, Y, and Z axes of the coordinate system 410. This X, Y, and Z positional data may be associated with one or more objects 105 in the monitoring area 110, with the X data related to the azimuth values, Y data related to the elevation values, and Z data related to the depth-distance values.

In certain circumstances, the orientation of the passive-tracking system 115 may change. For example, the initial X, Y, and Z axes of the system 115 may be defined when the system 115 is placed on a flat surface. If the positioning of the system 115 shifts, however, adjustments to the coordinate system 410 may be necessary. For example, if the system 115 is secured to a higher location in a monitoring area 110, the system 115 may be aimed downward, thereby affecting its pitch. The roll and yaw of the system 115 may also be affected. As will be explained below, the accelerometer 365 may assist in making adjustments to the coordinate system 410.

Referring to FIG. 3C, the passive-tracking system 115 is shown in which at least the pitch and roll of the system 115 have been affected. The yaw of the system 115 may have also been affected. In one arrangement, however, the change in yaw may be assumed to be negligible. The initial X, Y, and Z axes are now labeled as X′, Y′, and Z′ (each in solid lines), and they indicate the shift in the position of the system 115. In one embodiment, the system 115 can define adjusted X, Y, and Z axes, which are labeled as X, Y, and Z (each with dashed lines), and the adjusted axes may be aligned with the initial X, Y, and Z axes of the coordinate system 410.

To define the adjusted X, Y, and Z axes, first assume the adjusted Y axis is a vertical axis passing through the center of the initial X, Y, and Z axes. The accelerometer 365 may provide information (related to gravity) that can be used to define the adjusted Y axis. The remaining adjusted X and Z axes may be assumed to be at right angles to the (defined) adjusted Y axis. In addition, an imaginary plane may pass through the adjusted Y axis and the initial Z axis, and a horizontal axis (with respect to the adjusted Y axis) that lies on this plane may be determined to be the adjusted Z axis. The adjusted X axis is found by identifying the only axis that is orthogonal to both the adjusted Y axis and the adjusted Z axis. One skilled in the art will appreciate that there are other ways to define the adjusted axes.

Once the adjusted X, Y, and Z axes are defined, the initial X, Y, and Z coordinates may be converted into adjusted X, Y, and Z coordinates. That is, if a sensor or some other device produces X, Y, and Z coordinates that are based on the initial X, Y, and Z axes, the system 115 can adjust these initial coordinates to account for the change in the position of the system 115. When referring to (1) a three-dimensional position, (2) X, Y, and Z positional data, (3) X, Y, and Z positions, or (4) X, Y, and Z coordinates, such as in relation to one or more objects 105 being passively tracked, these terms may be defined by the initial X, Y, and Z axes or the adjusted X, Y, and Z axes of the coordinate system 410 (or even both). Moreover, positional data related to an object 105 is not necessarily limited to Cartesian coordinates, as other coordinate systems may be employed, such as a spherical coordinate system. No matter whether initial or adjusted positional data is acquired by a passive-tracking system 115, the system 115 may share such data with other devices.

In accordance with the description above, current frames from the components or sensors of the passive-tracking system 115 may include various positional data, such as different combinations of data associated with the X, Y, and Z positions, related to one or more objects 105. For example, the visible-light sensor 300 and the thermal sensor 310 may provide data related to the X and Y positions of an object 105, and the data from the ToF sensor 310 may relate to the X, Y, and Z positions of the object 105. In some cases, the data about the Z positions provided by the ToF sensor 310 may receive significant attention because it provides depth distance, and the data associated with the X and Y positions from the ToF sensor 310 may either be ignored, filtered out, or used for some other purpose (like tuning or confirming measurements from another sensor). As another example, a sonar device 355 (see FIG. 2) may be useful for determining or confirming X and Z positions of an object 105.

In one arrangement, tracking data from the sensors of the passive-tracking system 115 may be useful for optimizing the operation of the ToF sensor 310. For example, X- and Y-positional data from the visible-light sensor 300 or the thermal sensor 315 (or both) can be used to direct light from the ToF sensor 310 towards or away from (or both) certain portions of the monitoring area 110. As another example, Z-positional data from the sonar device 355 of the system 115 may be relied on to facilitate a similar operation or to cause other adjustments in the operation of the ToF sensor 310. In some cases, positional data from the ToF sensor 310 itself may be used to manage its operation.

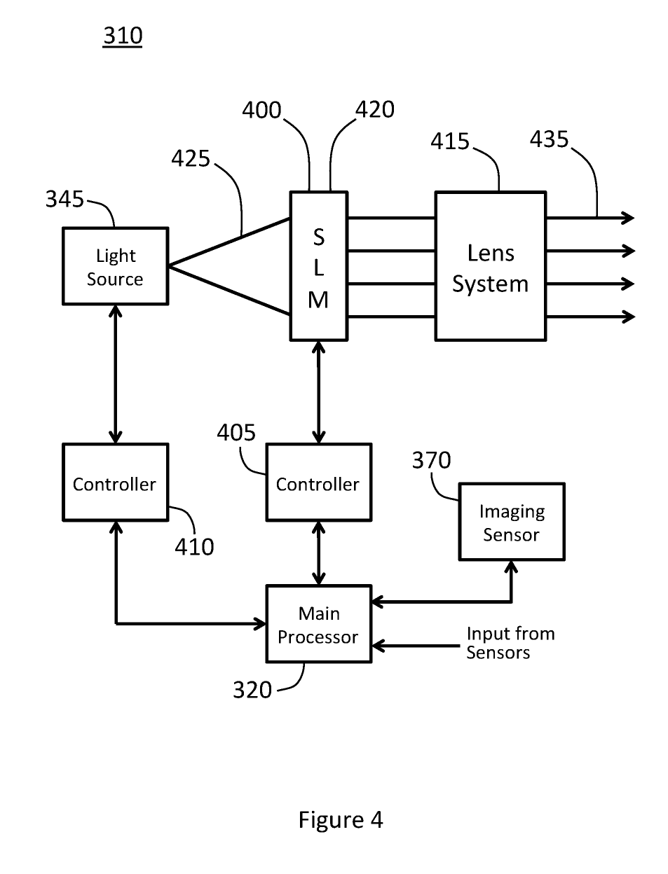

Before presenting examples of such a process, additional information about the ToF sensor 310 will be provided. Referring to FIG. 4, a block diagram that shows a possible configuration of the ToF sensor 310 is illustrated. As an example, the ToF sensor 310, as pointed out earlier, can include one or more modulated-light sources 345 and one or more detectors or imaging sensors 370. The ToF sensor 310 can also include one or more diffractive optical elements (DOE) 400, one or more controllers 405 for controlling the DOE 400, and one or more controllers 410 for controlling the modulated-light source 345. The ToF sensor 310 may also include one or more lens systems 415. In addition, the main processor 320 may be communicatively coupled to and control the operation of several of the components of the ToF sensor 310, such as the controller 405, the controller 410, and the lens system 415.

The processor 320 may also be communicatively coupled to and control the operation of the modulated-light source 345 and the DOE 400 via the controller 410 and the controller 405, respectively. The processor 320, as also previously noted, may receive input from the imaging sensor 370 of the ToF sensor 310 and from the other sensors of the passive-tracking system 115, such as the visible-light sensor 300, the thermal sensor 315, and the sonar device 355. Although the main processor 320, as presented in this configuration, may be a component separate and distinct from the ToF sensor 310, such an arrangement is not meant to be limiting, as the processor 320 or some other processor may be incorporated into or otherwise part of the ToF sensor 310.

In accordance with an earlier example, the modulated-light source 345 may be a light source that can emit light in the IR range, such as near-IR light. The light source 345, however, can be configured to emit light of other suitable wavelengths, including those of other non-visible light, visible light, or a combination of visible light and non-visible light. As another example, the light source 345 may be one or more lasers, although other illumination sources (such as light-emitting diodes (LED), incandescent lamps, or even those that produce light from a chemical reaction) may be employed.

In one arrangement, the modulated-light source 345 may be a laser that is modulated by an input signal, like a continuous-wave source such as a sinusoid or square wave, and emits light output 425. In this example, the light output 425 may be composed of the input signal riding on illumination light. In some cases, the main processor 320, via the controller 405, may modify the properties of the light output 425. For example, the main processor 320 can be configured to adjust the wavelength of the illumination light, the carrier signal, or both and to change the type of modulation applied to the illumination light. Moreover, if the ToF sensor 310 includes more than one light source 345, the main processor 320 can be further configured to selectively activate/deactivate any number of them. As an example, the light source(s) 345 may be turned on and off in a controlled ramp, although other schemes may be applicable here. If desired, the main processor 320 may also be configured to adjust the intensity of the illumination light, such as by controlling output power to the light source(s) 345. As will be seen below, dynamically controlling the power of the light source(s) 345 may be useful for certain types of modulation performed by the DOE 400.

Because the DOE 400 may be optically coupled to the light source 345, the DOE 400 can receive the light output 425 and can modulate the illumination light. As part of this process, the DOE 400 may only modulate the illumination light of the light output 425, thereby leaving the input signal unaffected. As will be explained below, through this modulation, the DOE 400 can effectively steer the illumination light to certain sections of a monitoring area 110 and away from other sections of the area 110.

In one example, the DOE 400 may be comprised of one or more spatial light modulators (SLM) 420, which can be configured to perform the modulation of the illumination light. Any number and type of SLMs 420 may be employed here. For example, the SLM 420 may be a digital micro-mirror device (DMD) in which the DMD's pixels are provided by individually addressable and movable mirrored surfaces of a micro-electro-mechanical system (MEMS). As another example, the SLM 420 may utilize liquid-crystal (LC) technology to carry out the modulation, such as a liquid-crystal display (LCD) SLM or a liquid-crystal-on-silicon (LCoS) display. As is known in the art, SLMs 420 that rely on LC technology are controlled by selectively applying voltage to the electrodes, which creates an electric field in the LC material. A DMD or LC SLM, in view of their architectures, may be dynamically operable, meaning the modulation that these devices may apply to the illumination light may be programmable or otherwise manageable. This control may be exerted by the main processor 320, through the controller 405.

Another example of an SLM 420 that may be employed here includes a micro-mechanical-slit-positioning system (MMSPS), which may have two or more modulation masks that are constructed of an opaque material. Both masks feature a number of slits or other openings that pierce the material to allow the selective passage of light through the mask. This system may also include an actuator than can shift one or both masks (with respect to each other). When either mask is moved, the width of the slits may change, anywhere between (and including) fully open and fully closed. When light reaches the system, the light is modulated by shifting one or both of the modulation masks to permit light to selectively pass through the masks. The main processor 320, through the controller 405, may control the actuator to manage the modulation of the illumination light. In another example, a number of slits may be incorporated into an optical phase shifter, which can be constructed of, for example, a transparent material with a controlled index of refraction and thickness.

In some cases, the SLM 420 may rely on a fixed modulation mask to modulate the illumination light. In this example, the modulation of the illumination light—and hence, the steering of such light—may be executed (or modified) by adjusting one or more properties of the light output 425 at the modulated-light source 345. Examples of such adjustments may include modifying the wavelength of the illumination light or the carrier (or both), the type of modulation applied to the illumination light, or the intensity of the illumination light, such as by controlling power output to or selectively activating/deactivating the light source(s) 345. As another option, these adjustments may also be performed if the SLM 420 is dynamically operable. The light source 345 (or a portion of the light sources 345 if there are a plurality of them), however, may also be fixed in that the properties of the light output 425 may remain unchanged, either permanently or for a certain period of time or in view of a particular event or condition.

The SLM 420 may be configured to modulate the amplitude, phase, or polarization of the illumination light or any combination of such properties of the illumination light. As previously noted, the SLM 420 may be configured to not affect the input signal of the light output 425. In the case of phase modulation, the SLM 420 may shift the phases of at least some of the beams of the illumination light, which can add a small delay to these beams. This process can produce a wavefront that is effectively spherical and may converge and focus on a target. This convergence may also result in the illumination light being directed away from certain areas. In another example, the wavefront may be flat but inclined, which may be useful for illuminating off-axis, far-away objects. (The focus of this wavefront would be at infinity).

For amplitude modulation, depending on the type of diffraction realized by the SLM 420, the SLM 420 can force the illumination light to form an illumination pattern that includes one or more peak intensities, along with minimum intensities. The peak intensities may be realized from the additive properties of light. In one arrangement, the peak intensities of the illumination pattern may be directed towards a target and away from other areas. Conversely, the minimum intensities of the illumination pattern may be directed towards certain areas that may be insignificant, at least for purposes of passively tracking an object 105. As part of the process of either modulating the phase or amplitude of the illumination light, the SLM 420 may polarize the illumination light. As mentioned above, the SLM 420 may modulate both the amplitude and phase of the illumination light (including simultaneously), and the principles of steering the illumination light towards and/or away from certain areas may also apply in such an arrangement. For simultaneous phase and amplitude modulation, for a phase-only SLM 420, two overlapped output planes may be imposed with both amplitude and phase constraints of a target beam. The constrained areas in the two output planes may be complementary, so the amplitude and phase of the beam in the entire output plane may be constrained.

As an option, the ToF sensor 310 may have a plurality of SLMs 420, each of which may be capable of modulating the amplitude, phase, or polarization (or any combination of them) of the illumination light. If more than one SLM 420 is part of the configuration, each SLM 420 may have one or more modulated-light sources 345 for providing the illumination light, or at least one of the light sources 345 may emit illumination light to be directed to two or more SLMs 420. If a light source 345 provides illumination light to two or more SLMs 420, the illumination light may be shared equally between or among the SLMs 420 or may be split unevenly between or among them.

No matter the type(s) of SLM 420 or modulation used in the ToF sensor 310, the illumination light may be selectively steered to (or away) from certain areas. The light that exits the SLM 420 may be referred to as steered light 435, which may be comprised of the modulated illumination light and the input signal riding on the modulated illumination light. Because the illumination light may be dynamically steered, the input signal generated at the light source 345 may also be similarly steered. This process, however, may not affect the properties of the input signal. As such, the ToF sensor 310 may maintain its ability to determine depth distances, and in fact, this feature may be improved in view of the more efficient use of the illumination light. In one arrangement, the lens system 415 may be optically coupled to the SLM 420 and, as an example, may be a beam homogenizer. The beam homogenizer may smooth out irregularities in the modulated illumination light of the steered light 435 from the SLM 420. As another example, to compensate for deflection angles of the illumination light, the lens system 415 may be an afocal lens system that provides angular magnification. In another arrangement, the ToF sensor 310 may not include a lens system 415, and the SLM 420 may provide direct illumination. Direct illumination may be appropriate for, for example, large distances and low angles of view.

The ToF sensor 310 may be configured to avoid modulating the illumination light in certain circumstances. In such an event, the SLM 420 may be set to not apply any modulation to the light output 425, which can cause the ToF sensor 310 to emit light throughout the monitoring area 110 in a diffused manner. In another arrangement, the ToF sensor 310 may be configured with a bypass channel (not shown) that would enable the light output 425 to selectively bypass the SLM 420, depending on certain conditions. As with the previous example, the light output 425 that passes through the bypass channel may be diffusively emitted from the ToF sensor 310.

As noted above, the illumination light, with the input signal riding on it, can be steered towards certain sections of the monitoring area 110. For example, an object 105 may be present in the monitoring area 110, and the illumination light (and, hence, the input signal) can be directed towards the object 105. At least some of the illumination light and input signal may be reflected off the object 105 and may be detected by the imaging sensor 370. In some cases, the combination of the steered illumination light and the input signal may be referred to as the modulated light. The imaging sensor 370 may then convert the captured reflections into raw data that it can feed to the main processor 320. The main processor 320, based on this raw data, may then generate positional or tracking data associated with the object 105. The tracking data may include, for example, X, Y, and Z coordinates, with the Z coordinate arising from a depth distance for the object 105 with respect to the ToF sensor 310.

In one arrangement, the main processor 320 may receive the frames that are generated by the other sensors of the passive-tracking system 115, such as the visible-light sensor 300, the thermal sensor 315, the sonar device 355, or any combination thereof. For example, the visible-light sensor 300 and the thermal sensor 315 may generate frames that include data about one or more objects 105, at least one of which may be a human, in the monitoring area 110. The main processor 320 may receive and analyze these frames to determine whether any of the objects 105 are suitable for passive tracking. As an example, an object 105 that is human may be suitable for passive tracking.

Continuing with the example, tracking data about the objects 105 detected by the visible-light sensor 300 and the thermal sensor 315 may form part of the data of the frames generated by these sensors. The processor 320 may extract and further process the tracking data to determine positional coordinates associated with the objects 105. In one arrangement, the processor 320 may determine the positional coordinates only for the objects 105 that have been identified as suitable for passive tracking (or are otherwise already being passively tracked). In the case of the frames from the visible-light sensor 300 and the thermal sensor 315, the positional coordinates may be X and Y coordinates associated with the objects 105 that have been designated as being suitable for passive tracking.

Positional coordinates may be acquired from tracking data generated by other sensors of the passive-tracking system 115. For example, main processor 320 may determine X and Z coordinates from the frames produced by the sonar device 355. Similar positional data may be obtained from frames generated by a radar unit. As another example, positional data may be received from different passive-tracking systems 115 or other devices or systems that may be remote to the instant passive-tracking system 115.

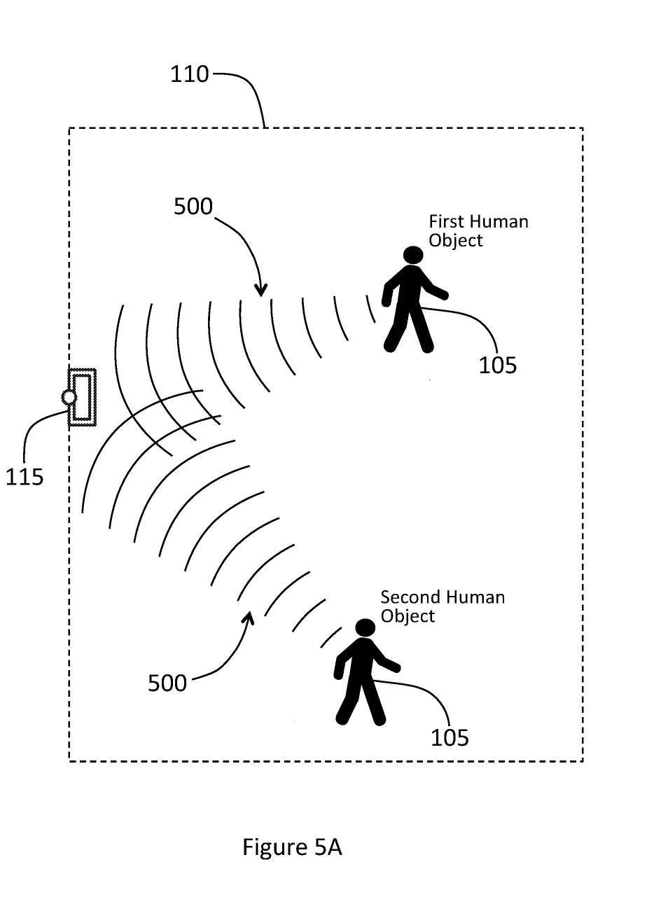

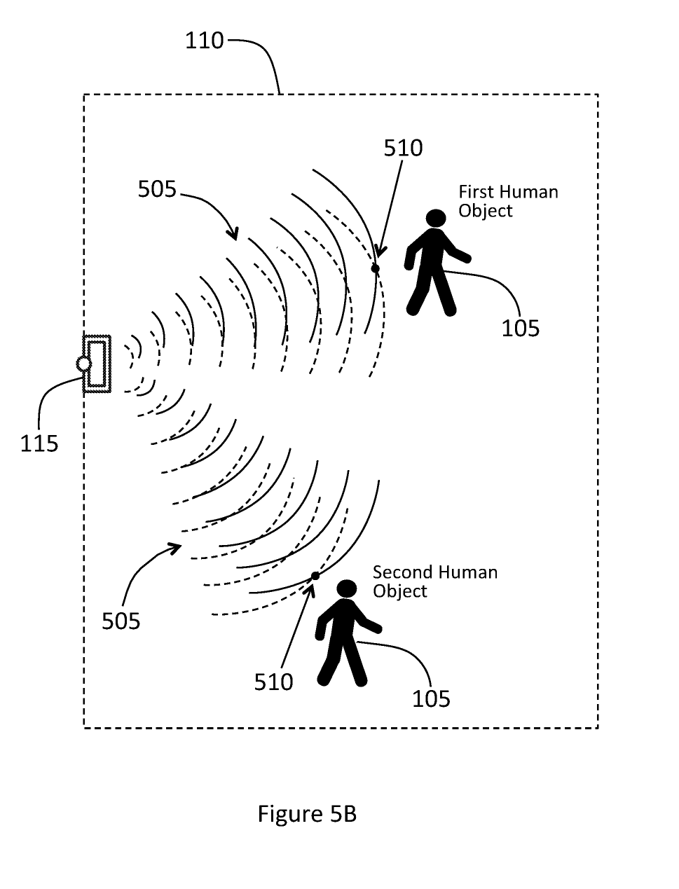

In one embodiment, the main processor 320 may use the tracking data from the other sensors of the passive-tracking system 115 (or other device or system) to dynamically control the steering of the illumination light of the ToF sensor 310. Referring to FIGS. 5A and 5B, examples of a monitoring area 110 that has two human objects 105—a first human object 105 and a second human object 105—present in the area 110 are shown. Reference will also be made to FIG. 4 for purposes of the description related to FIGS. 5A and 5B. In these examples, the processor 320 may have obtained X and Y coordinates with respect to the first and second human objects 105. Based on this information, the processor 320 may signal the controller 405 to cause the SLM 420 to adjust the modulation of the illumination light to cause the illumination light to be steered towards one or both of the first and second human objects 105.

For example, referring to the passive-tracking system 115 in FIG. 5A, the SLM 420 of the ToF sensor 310 may be operating in a phase-modulation mode. The system 115 may also be operating in a monitoring area 110. Based on the positional data from the other sensors, the SLM 420 may adjust the phase modulation that it applies to the illumination light (if such an adjustment is necessary). As a result, a wavefront 500, comprised of the illumination light (and the carrier wave), may be generated that causes the illumination light to focus on and converge at, for example, the location of the first human object 105. This beam-steering technique may improve the operation of the ToF sensor 310 in at least two ways. First, the intensity of the illumination light with respect to the target—in this case, the first human object 105—is increased, which improves the operating range of the ToF sensor 310. Second, because the illumination light is focused on the target, the amount of stray light that reflects off non-target surfaces is decreased, which reduces the distortion caused by MPP.

Reflections of the input signal riding on the illumination light from the first human object 105 may be captured by the imaging sensor 370, and the main processor 320 may receive the data from the sensor 370 and determine positional coordinates associated with the first human object 105. As an example, the processor 320 may determine at least a depth distance for the first human object 105 with respect to the ToF sensor 310 which can enable the processor 320 to provide Z coordinate for the first human object 105. (The data from the sensor 370 may also enable the processor to determine X and Y coordinates for the first human object 105.) This positional information may be used to complete a full set of positional coordinates associated with the first human object 105 in which at least some of the set originates from other sensors of the passive-tracking system 115. Such information may also be used to confirm coordinates that are realized from the other sensors.

A similar result may be realized from other modulation techniques. For example, the SLM 420 may be set to modulate the amplitude of the illumination light. Based on the positional data associated with the first human object 105, the SLM 420 may produce an illumination pattern 505 in which one or more peak intensities 510 are directed towards the first human object 105, which can be seen in FIG. 5B. The peak intensities 510 of the illumination pattern 505 may result from the additive properties of light. From the reflections of the input signal riding on the illumination light off the first human object 105, the main processor 320 can determine relevant positional information, including a Z coordinate, with respect to the first human object 105. In addition, similar to the phase modulation, this illumination pattern 505 may increase the intensity of the illumination light with respect to the first human object 105, thereby effectively increasing the range of the ToF sensor 310. The illumination pattern 505 may also result in a less light reaching portions of the monitoring area 110 that are currently unoccupied by the first human object 105. As such, degradation that arises from MPP may be significantly reduced. No matter the type of modulation applied to the illumination light, by selectively modulating the illumination light, constructive interference of the illumination light may be realized in the vicinity of an object that may be a target for passive tracking and destructive interference of the illumination light may be produced in insignificant areas, like those unoccupied by such an object.

Although examples of phase and amplitude modulation are presented to show how the performance of the ToF sensor 310 may be improved, the description here is not so limited. In particular, other modulation techniques or processes that can otherwise change the properties of the illumination light of the ToF sensor 310 to steer it towards a target that is or is about to be passively tracked and away from areas that may not be occupied by the target may be employed here.

As described thus far, the steering of the illumination light from the ToF sensor 310 may be based on the tracking data provided by the frames generated by one or more other sensors of the passive-tracking system 115. This tracking data may be helpful in initially directing the illumination light towards and/or away from certain sections of the monitoring area 110. Once the ToF sensor 310 performs the initial steering, the tracking data from the other sensors may be used to also adjust the direction of the illumination light.

For example, the first human object 105 may move within the monitoring area 110, following the initial setting or steering of the illumination light. From the tracking data of the other sensors of the passive-tracking system 115, such as the visible-light sensor 300, the thermal sensor 315, the sonar device 355, or any combination thereof, the main processor 320 can determine new or updated positional coordinates of the first human object 105. Subsequently, the processor 320 can signal the SLM 420 (through the controller 405) to make any necessary adjustments to cause the illumination light to be redirected to the first human object 105 at the new location. This process may be repeated to enable the SLM 420 to continuously make adjustments to the modulation of the illumination light to steer it towards a moving target. Such adjustments may also cause the illumination light to be steered away from one or more updated sections of the monitoring area 110, such as those that may no longer be occupied by the moving target.

In one embodiment, the ToF sensor 310 may operate in a self-sufficiency mode in which it effectively relies on its own tracking data to set or adjust the operation of the SLM 420. For example, in an initial operational stage, such as prior to the presence (or detection) of an object 105 in the monitoring area 110, the ToF sensor 310 may emit the modulated light from the modulated-light source 345 without any modulation from the SLM 420. In this stage, the light may pass through the SLM 420 unaffected or may simply bypass it. The emitted light may be diffuse in nature and may arbitrarily illuminate the monitoring area 110.

If, for example, a first human object 105 enters the monitoring area 110, the light reflected off it may enable the main processor 320 to determine that a potential candidate for passive tracking is currently in the monitoring area 110. In such a case, the processor 320 may signal the SLM 420 (through the controller 405) to begin modulating the illumination light to cause the illumination light to be steered towards the first human object 105. If the first human object 105 moves, based on the received reflections of illumination light and the input signal, the processor 320 may be able to detect the movement and estimate a speed and direction of the first human object 105. Based on this information, the SLM 420 may then adjust the modulation to steer the illumination light towards the new location. By continuously acquiring information from the reflections of illumination light, the SLM 420 may continue to make any necessary adjustments to achieve optimal results. Even in the case of steered illumination light, a not insignificant amount of illumination light may reach areas outside an intended target zone, depending on the contrast of the diffractive steering. This leakage of illumination light may enable the ToF sensor 310 to generate data in relation to areas outside the deliberately illuminated area. This leakage data may be used to assist the tracking of a target, such as in the self-sufficiency mode.

As another option, if the processor 320 is unable to determine a satisfactory estimate of the speed and direction of the first human object 105, processor 320 can direct the SLM 420 to perform trial-and-error adjustments in an effort to locate the first human object 105. The trial-and-error adjustments may be based on known limits of human speed and known restrictions in the monitoring area 110 that may impede the movement of the first human object 105 in a particular direction. Examples of such impediments in the monitoring area 110 include walls or furniture. If an initial redirection of the illumination light fails to produce a positive result from the data generated by the imaging sensor 370, the SLM 420 can try one or more other adjustments until the first human object 105 is reacquired. As part of this solution, the SLM 420 may also temporarily suspend modulation of the illumination light, and the target may be reacquired by emitting the light in a diffusive (or wide-angle) manner. Once the first human object 105 is detected again, the SLM 420 may again modulate the illumination light to steer it towards the new location of the first human object 105. As also part of this solution, the ToF sensor 310 may repeatedly switch between generating frames based on diffusive illumination and modulated illumination.

As another example, the ToF sensor 310 may rely on the tracking data of other sensors of the passive-tracking system 115 for an initial setting or adjustment of the modulation executed by the SLM 420. Following this initial setting or adjustment, the ToF sensor 310 may rely on its own tracking data as a basis for any further adjustments by the SLM 420. Further, at any time while an object 105 is being passively tracked, the ToF sensor 310 may rely on tracking data from the other sensors of the passive-tracking system 115 or a combination of tracking data from itself and the other sensors. Tracking data from the ToF sensor 310 may supplement or otherwise confirm the tracking data from the other sensors, such as for purposes of adjusting the SLM 420. For example, the Z coordinate associated with an object 105 that is acquired from the tracking data of the ToF sensor 310 may supplement the X and Y coordinates obtained from the visible-light sensor 300 and/or the thermal sensor 315 to complete a full set of 3D coordinates. As another example, the X, Y, or Z coordinates from the tracking data of the ToF sensor 310 may be used to confirm similar coordinates acquired from the operation of one or more other sensors of the system 115.

More than one target may be tracked in accordance with the previous discussion, such as when two or more targets are present in the monitoring area 110. For example, the main processor 320, once it determines at least some positional information associated with the second human object 105, can signal the controller 405 to cause the SLM 420 to steer the illumination light towards the second human object 105. Referring to FIG. 5A again, another wavefront 500 may converge on the second human object 105. In addition, referring to FIG. 5B, another illumination pattern 505 may be created, with one or more peak intensities 510 directed towards the second human object 105. As before, in either case, the initial positional information of the second human object 105 may originate from the frames generated by the other sensors of the passive-tracking system 115, the ToF sensor 310 solely, or a combination of the two. Based on the reflections of the illumination light and input signal, the processor 320 may also at least determine a depth distance and, hence, a Z coordinate for the second human object 105. Adjustments to the modulation by the SLM 420 to account for movement by the second human object 105 may be performed in accordance with the discussion presented above.

In one arrangement, the ToF sensor 310 may track multiple targets simultaneously. For example, the SLM 420 may be configured to produce numerous wavefronts 500 or illumination patterns 505 at the same time, such as producing their sums. Their relative intensities can also be controlled, such as through the use of weighted sums. In either case, the multiple objects 105, such as the first and second human objects 105, can be dynamically illuminated at the same time.

In another example, to enable simultaneous tracking of the first and second human objects 105 (or other objects 105), the SLM 420 may quickly shift between different modes of operation. For example, the SLM 420 may be modulating the phase of the illumination light to steer it towards the first human object 105. This particular modulation may be relevant to the first human object 105 based on the location of the first human object 105 in the monitoring area 110. The SLM 420 may then quickly adjust the phase modulation to cause the illumination light to be directed towards the second human object 105. This redirection may last for a brief period before the SLM 420 shifts back to the phase modulation associated with the first human object 105, thereby once again directing the illumination light to the first human object 105. The SLM 420 may continue to shift between the different modes of operation to ensure the illumination light is directed towards the first and second human objects 105, and away from sections of the monitoring area 110 that neither occupies, at least until one or more conditions or events are realized, examples of which will be presented below.

This shifting between the different modes of operation may also be performed when one or both of the first and second human objects 105 are moving. In some cases, the amount of time the SLM 420 spends in the different modes of operation related to the different objects 105 may or may not be at least substantially equal. For example, if only the first human object 105 is currently moving, the SLM 420 can spend more time in the mode of operation that causes the illumination light to be steered towards the first human object 105 in comparison to that of the second human object 105. In this example, if the second human object 105 remains stationary, the SLM 420 may operate exclusively in the mode of operation related to tracking the first human object 105, at least for a certain period of time. This particular configuration, however, may be reversed if the second human object 105 begins to move or the first human object 105 slows down or ceases moving (or a combination thereof). The movement of the second human object 105, in this example, may be determined from an analysis of the tracking data generated by the other sensors of the passive-tracking system 115, the ToF sensor 310, or a combination thereof. If the tracking data indicates that one of the first and second human objects 105 is no longer in the monitoring area 110, the SLM 420 may cease shifting between mode of operation and may focus on the remaining human object 105.

As shown here, the SLM 420 may shift between different modes of operation for the same type of modulation. This process, however, may also include switching from one form of modulation to another. For example, the SLM 420 may perform phase modulation of the illumination light with respect to the period designated for the first human object 105 and may shift to amplitude modulation for that of the second human object 105. The SLM 420 may even be configured to cycle between different modulation types for a particular object 105. In particular, in the example above, the SLM 420, when shifting its mode of operation to steer the illumination light back towards the first human object 105, may modulate the amplitude of the illumination light during the period designated for the first human object 105, as opposed to simply repeating the phase modulation that was carried out in the previous period for the first human object 105.

Although the examples above illustrate how the ToF sensor 310 may selectively guide illumination light to two human targets, the ToF sensor 310 may be configured to track more than two targets, either of which may be human or non-human. Additionally, other arrangements may be used to support multi-target illumination. For example, instead of providing a single SLM 420 that shifts between different modes of operation, the ToF sensor 310 can be equipped with two or more SLMs 420. In this case, the main processor 320 may assign the SLMs 420 to different targets in the monitoring area 110. Moreover, each of the SLMs 420 may be provided with a modulated-light source 345, or any number of the SLMs 420 may share modulated-light sources 345. If the number of objects 105 in the monitoring area 110 is fewer than the number of SLMs 420, one or more of the SLMs 420 and its corresponding light source 345 may be deactivated. The number of SLMs 420 deactivated may be set such that the number of operational (or active) SLMs 420 is equal to the number of objects 105 that are deemed to be candidates for passive tracking. In an alternative arrangement, instead of deactivating the affected SLMs 420 and the light sources 345, the SLMs 420 may simply avoid modulating the illumination light from the light sources. If so, the illumination light exiting (or even bypassing) the SLMs 420 may be diffusively emitted into the monitoring area 110. If problems arise from MPP, the light sources 345 of the unneeded SLMs 420 may be shut off. In either case (switching by the SLM 420 or implementing multiple SLMs 420), the ToF sensor 310 may steer illumination light towards two or more targets simultaneously.

No matter the number of SLMs 420 or modulated-light sources 345 the ToF sensor 310 may contain, if no objects 105 in the monitoring area 110 currently warrant passive tracking, all the light sources 345, the SLMs 420, or both may be deactivated. As an example, deactivation of these components may occur if the tracking data from any of the sensors (including the ToF sensor 310) of the passive-tracking system 115 indicate the lack of presence of a human (or some other suitable candidate for passive tracking) in the monitoring area 110. This deactivation may remain in place until, for example, tracking data from the other sensors of the passive-tracking system 115 indicate that an object 105 that may be a candidate for passive tracking has entered or is otherwise now detected in the monitoring area 110. In addition, the deactivation may be a sleep state in which the light source 345 may periodically wake up to emit light in the monitoring area 110 in, for example, a diffusive manner. If the reflections of light indicate that a new object 105 is in the monitoring area 110, the light source 345 and the SLM 420 may be returned to a normal operational state. If another new object 105 is detected from the tracking data of the ToF sensor 310 or the other sensors of the passive-tracking system 115 (or both), the ToF sensor 310 can transition to support multi-target illumination, as described above.

As previously explained, the modulation of the illumination light may be carried out by adjusting one or more properties of the light output 425 at the modulated-light source 345. Examples of the properties that may be adjusted at the light source 345 may include the wavelength of the illumination light or the input signal (or both), the type of modulation applied to the illumination light (at the light source 345), or the intensity of the illumination light. This form of modulation may either supplement the modulation performed by the SLM 420 or supplant it. Accordingly, adjustments at the light source 345 may facilitate (or at least assist in facilitating) the beam steering described herein, including the illustrations related to multi-target illumination.

In one arrangement, the ToF sensor 310 may alter its operation, depending on the location of the object 105 being tracked. For example, the tracking data from the other sensors of the passive-tracking system 115 or the ToF sensor 310 (or both) may indicate that the object 105 has moved within a predetermined distance of the ToF sensor 310. In this case, the operational range of the ToF sensor 310 may not be as much of a concern in comparison to when the object 105 is farther away. The effects of MPP may also not be as severe when the object 105 is within this predetermined distance. Thus, the ToF sensor 310 may correspondingly diffuse the steered illumination light to reduce the originally increased amount of illumination light directed at the object 105.

For example, if the object 105 is close enough to the ToF sensor 310, the ToF sensor 310 may stop the modulation of the illumination light by the SLM 420 and emit the light diffusively throughout the monitoring area 110. The positional information associated with the object 105 may still be obtained in this condition. As another example, instead of stopping the modulation, the ToF sensor 310 may alter the modulation to reduce the intensity of the illumination light with respect to the object 105. For example, the phase modulation may be adjusted to cause the wavefront 500 of FIG. 5A to become more diffuse, such as if its point of convergence is positioned behind the object 105. Similarly, the amplitude modulation may be modified to reduce the peak intensity of the illumination light reaching the object 105. As another option, the intensity of the light output 425 can be reduced at the modulated-light source 345, either along with the adjustments made by the SLM 420 or in lieu of them. A sliding scale may be implemented here to enable modifications to be made in proportion to the distance between the object 105 and the ToF sensor 310.

If the object 105 moves away from the ToF sensor 310, these changes can be correspondingly reversed, which can include their complete removal if the object 105 moves outside the predetermined distance. In one embodiment, the changes described here may only be implemented where potential damage may occur to the object 105 as it moves within the predetermined distance. For example, if the object 105 is detected to be a human or some other biological entity that may be injured by illumination light above a certain intensity, the modifications shown here may be implemented if the object 105 gets too close to the ToF sensor 310. This principle may also apply to non-biological entities that may be sensitive to higher intensities of light, like the lens of a camera. Conversely, if the passive-tracking system 115 determines the object 105 to be a machine that is typically not affected by the increased intensities, the normal modulation of the illumination light may continue, as the safety measures exemplified here may not be necessary.

The use of a diffractive optical element in the ToF sensor 310 may increase the light efficiency of the ToF sensor 310. For example, in the case of an SLM 420 in phase-modulation mode, the SLM 420 is effectively a lossless device in that it steers light away from unimportant areas and towards areas of interest, such as one that is occupied by one or more objects 105 that are candidates for passive tracking or are already being passively tracked. That is, the amount of light that is emitted but does not illuminate a particular target may be significantly reduced, even though the amount of space occupied by the target may be relatively small in comparison to the monitoring area 110. If the SLM 420 is operating in an amplitude-modulation mode, a portion of the light generated by the light source 345 may be blocked by the SLM 420, meaning that such light may not be emitted by the ToF sensor 310. Although not as efficient as phase modulation, the light steering that results from amplitude modulation results in a much greater portion of the generated light reaching an area occupied by an object 105 that is a candidate for passive tracking or is being passively tracked. In the case of phase modulation, the amount of light produced by the ToF sensor 310 may be controlled at the light source 345, such as by adjusting power to the light source 345, if it is necessary to reduce the amount of such light.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein.

Furthermore, arrangements described herein may take the form of a computer program product embodied in one or more computer-readable media having computer-readable-program code embodied (e.g., stored) thereon. Any combination of one or more computer-readable media may be utilized. The computer-readable medium may be a computer-readable signal medium or a computer-readable storage medium. The phrase “computer-readable storage medium” is defined as a non-transitory, hardware-based storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable storage medium may be transmitted using any appropriate systems and techniques, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects herein can be embodied in other forms without departing from the spirit or essential attributes thereof. Accordingly, reference should be made to the following claims, rather than to the foregoing specification, as indicating the scope hereof.

What is claimed is:

1. A time-of-flight sensor for dynamically controlling modulated light, comprising:
a light source configured to emit modulated light in a monitoring area, wherein the modulated light is comprised of an input signal riding on illumination light;
a diffractive optical element optically coupled to the light source, wherein the diffractive optical element is configured to receive the modulated light and to modulate the illumination light of the modulated light; and
a processor that is communicatively coupled to the diffractive optical element, wherein the processor is configured to:
receive tracking data from one or more sensors of a passive tracking system, wherein the tracking data is associated with an original object in the monitoring area being passively tracked by the passive tracking system;
based on the tracking data, signal the diffractive optical element to adjust the modulation of the illumination light to steer the illumination light towards the original object in the monitoring area to increase the amount of illumination light striking the original object and to steer the illumination light away from one or more sections of the monitoring area unoccupied by the original object.

2. The time-of-flight sensor of claim 1, wherein the diffractive optical element is a spatial light modulator that is configured to modulate the phase or amplitude of the illumination light.

3. The time-of-flight sensor of claim 1, wherein the diffractive optical element is configured to modulate the illumination light without affecting the input signal.

4. The time-of-flight sensor of claim 1, wherein the tracking data includes new positional data associated with the original object that corresponds to movement of the original object to a new location in the monitoring area.

5. The time-of-flight sensor of claim 4, wherein the processor is further configured to, based on the new positional data, signal the diffractive optical element to adjust the modulation of the illumination light to steer the illumination light towards the original object at the new location and to steer the illumination light away from one or more updated sections of the monitoring area unoccupied by the original object.

6. The time-of-flight sensor of claim 1, wherein the tracking data is associated with both the original object and a new object in the monitoring area being passively tracked by the passive tracking system and wherein the processor is further configured to, based on the tracking data, signal the diffractive optical element to adjust the modulation of the illumination light to steer the illumination light towards both the original object and the new object in the monitoring area and to steer the illumination light away from one or more sections of the monitoring area unoccupied by both the original object and the new object.

7. The time-of-flight sensor of claim 1, further comprising a detector configured to receive reflections of the modulated light from the original object and the processor is further configured to determine a depth distance of the original object based on the received reflections of modulated light.

8. The time-of-flight sensor of claim 1, wherein the processor is communicatively coupled to the light source and the processor is further configured to signal the light source to adjust the wavelength of the illumination light.

9. The time-of-flight sensor of claim 1, wherein the time-of-flight sensor is a sensor that is part of the passive tracking system and the one or more sensors of the passive tracking system further comprise a visible-light sensor, a thermal sensor, or a sonar device.

10. The time-of-flight sensor of claim 1, wherein the original object is a human and the processor is further configured to:
receive tracking data from the sensors that indicates the lack of presence of the human; and
in response to the lack of presence of the human, deactivate the light source.

11. A method of dynamically controlling a light source, comprising:
emitting in a monitoring area modulated light that includes an input signal riding on illumination light;
detecting an original object in the monitoring area and passively tracking the object;
based on passively tracking the original object, receiving tracking data associated with the original object;
based on the tracking data, steering the illumination light towards the original object in the monitoring area to increase the amount of illumination light striking the original object and away from one or more sections of the monitoring area that are unoccupied by the original object;
receiving reflections of the modulated light from the original object; and
based on the received reflections, providing a depth distance of the original object in the monitoring area.

12. The method of claim 11, wherein passively tracking the object comprises passively tracking the object with one or more sensors of a passive tracking system, wherein the sensors comprise a visible-light sensor, a thermal sensor, a time-of-flight sensor, or a sonar device and receiving the tracking data associated with the original object comprises receiving the tracking data from one or more of the visible-light sensor, the thermal sensor, the time-of-flight sensor, or the sonar device.

13. The method of claim 11, wherein steering the illumination light towards the original object in the monitoring area and away from one or more sections of the monitoring area that are unoccupied by the original object is facilitated by selectively modulating the phase or amplitude of the illumination light.

14. The method of claim 11, wherein steering the illumination light towards the original object in the monitoring area and away from one or more sections of the monitoring area that are unoccupied by the original object is facilitated by selectively adjusting the wavelength of the illumination light.

15. The method of claim 11, further comprising:
receiving updated tracking data associated with the original object indicating the original object has moved to a new location in the monitoring area;
based on the updated tracking data, steering the illumination light towards the new location of the original object in the monitoring area and away from one or more updated sections of the monitoring area that are unoccupied by the original object.

16. The method of claim 15, further comprising:
receiving reflections of the modulated light from the original object in the new location of the monitoring area; and
based on the received reflections of the modulated light from the original object in the new location, providing an updated depth distance of the original object in the monitoring area.

17. The method of claim 11, further comprising:
receiving updated tracking data associated with the original object and a new object in the monitoring area at the same time as the original object;
based on the updated tracking data, steering the illumination light towards both the original object and the new object in the monitoring area and away from one or more sections of the monitoring area that are unoccupied by both the original object and the new object.

18. A method of increasing an operating range of a time-of-flight sensor in a monitoring area while simultaneously reducing the effects of multipath propagation arising from the operation of the time-of-flight sensor, comprising:
emitting from the time-of-flight sensor modulated light that includes an input signal riding on non-visible illumination light;
receiving tracking data associated with an object in the monitoring area;
based on the tracking data, modulating the phase of the illumination light to steer the illumination light towards the object in the monitoring area to increase the amount of illumination light directed at the object and away from one or more sections of the monitoring area that are unoccupied by the original object to minimize the amount of illumination light reaching the sections;
receiving reflections of the modulated light from the object; and
based on the received reflections, providing a depth distance of the object in the monitoring area.

19. The method of claim 18, wherein receiving tracking data associated with the object comprises receiving tracking data associated with the object from one or more sensors of a passive tracking system configured to passively track the object in the monitoring area.

20. The method of claim 18, further comprising:
receiving updated tracking data associated with the object that indicates the object is in a new location of the monitoring area;
based on the updated tracking data, modulating the phase of the illumination light to steer the illumination light towards the new location of the object and away from one or more updated sections of the monitoring area that are unoccupied by the object, wherein the updated sections include sections previously and newly unoccupied by the object.

21. The method of claim 18, further comprising:
determining that the object is within a predetermined distance of the time-of-flight sensor; and
based on the determination, correspondingly diffusing the steered illumination light to reduce the increased amount of illumination light directed at the object.
